(19) United States
(12) Patent Application Publication
(10) Pub. No.: US 2022/0281175 A1
(43) Pub. Date: Sep. 8, 2022

(54) LASER CALIBRATION DEVICE FOR ADDITIVE MANUFACTURING

(71) Applicants: General Electric Company, Schenectady, NY (US); Concept Laser GmbH, Lichlenfels (DE)

(72) Inventors: Xiaolei Shi, Niskayuna, NY (US); Jinjie Shi, Mason, OH (US); Victor Petrovich Ostroverkhov, Ballston Lake, NY (US); Udo Burggraf, Neuhof (DE); Joseph Edward Hampshire, West Chester, OH (US); Pinghai Yang, Niskayuna, NY (US)

(21) Appl. No.: 17/189,568

(22) Filed: Mar. 2, 2021

(51) Int. Cl. B29C 64/393; B23K 26/70; G01B 11/27; B29C 64/153; B29C 64/273; B33Y 30/00; B33Y 50/02

(52) U.S. Cl. CPC B29C 64/393; B23K 26/702; G01B 11/272; B29C 64/153; B29C 64/273; B33Y 30/00; B33Y 50/02; B23K 26/127

(57) ABSTRACT

A laser calibration device for calibrating an energy beam used in additive manufacturing, the laser calibration device including a body configured to be disposed in an additive manufacturing process chamber; a cover for the body, the cover comprising a plurality of holes; a photodiode; and a coating disposed on the body and configured to optically couple the photodiode with the plurality of holes, wherein the photodiode is configured to sense one or more parameters of the energy beam for determining calibrating instructions for the energy beam.

### FIELD

The present disclosure relates to laser calibration devices for additive manufacturing systems.

### BACKGROUND

Additive manufacturing processes typically create three-dimensional objects by successively applying and curing layers of a medium on a build plate. One exemplary method of additive manufacturing uses an energy beam emitted by a laser light source to consolidate the medium on the build plate one layer at a time. The energy beam is selectively guided around the build plate and selectively irradiates the medium.

Typical additive manufacturing techniques direct the laser light source along a guided path around the build plate in response to print instructions. Even minor errors in the guided path can alter the shape of the three-dimensional object being manufactured. Accordingly, industries utilizing additive manufacturing continue to demand improvements to calibration systems to ensure accurate build quality and reduce issues associated with misprints.

### BRIEF DESCRIPTION

Aspects and advantages of the invention will be set forth in part in the following description, or may be obvious from the description, or may be learned through practice of the invention.

In one exemplary embodiment of the present disclosure, a laser calibration device for calibrating an energy beam used in additive manufacturing, the laser calibration device comprising: a body configured to be disposed in an additive manufacturing process chamber; a cover for the body, the cover comprising a plurality of holes; a photodiode; and a coating disposed on the body and configured to optically couple the photodiode with the plurality of holes, wherein the photodiode is configured to sense one or more parameters of the energy beam for determining calibrating instructions for the energy beam

According to another exemplary embodiment, an additive manufacturing system comprising: an additive manufacturing process chamber having a build plate defining a build surface; a laser light source configured to emit an energy beam toward the build surface; and a laser calibration device disposed along the build surface, the laser calibration device comprising: a body configured; a cover for the body, the cover comprising a plurality of holes; a photodiode; and a coating disposed on the body and configured to optically couple the photodiode with the plurality of holes, wherein the photodiode is configured to sense one or more parameters of the energy beam for determining calibrating instructions for the energy beam

According to another exemplary embodiment, A method of calibrating a laser light source used in additive manufacturing, the method comprising: activating a laser calibration device in an additive manufacturing process chamber; emitting an energy beam from the laser light source toward a build surface of the additive manufacturing process chamber; sensing the energy beam at a photodiode of the laser calibration device, the energy beam passing through a plurality of holes in the laser calibration device and being redirected to the photodiode.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 is a schematic view of an additive manufacturing system including a laser calibration device in accordance with an exemplary embodiment of the present disclosure.

FIG. 2 is a plot of energy beam pulses sensed by a photodetector of the additive manufacturing system over time in accordance with an exemplary embodiment of the present disclosure.

FIG. 3 is a perspective view of the laser calibration device in accordance with an exemplary embodiment of the present disclosure.

FIG. 4 is a flow chart illustrating a method of calibrating a laser light source used in additive manufacturing in accordance with an exemplary embodiment of the present disclosure.

### DETAILED DESCRIPTION OF THE DRAWINGS

Reference now will be made in detail to present embodiments of the invention, one or more examples of which are illustrated in the accompanying drawings. The detailed description uses numerical and letter designations to refer to features in the drawings. Like or similar designations in the drawings and description have been used to refer to like or similar parts of the invention.

The word “exemplary” is used herein to mean “serving as an example, instance, or illustration.” Any implementation described herein as “exemplary” is not necessarily to be construed as preferred or advantageous over other implementations. Moreover, each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, the terms “first,” “second,” and “third” may be used interchangeably to distinguish one component from another and are not intended to signify location or importance of the individual components. The singular forms “a,” “an,” and “the” include plural references unless the context clearly dictates otherwise. The terms “coupled,” “fixed,” “attached to,” and the like refer to both direct coupling, fixing, or attaching, as well as indirect coupling, fixing, or attaching through one or more intermediate components or features, unless otherwise specified herein. As used herein, the terms “comprises,” “comprising,” “includes,” “including,” “has,” “having” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus. Further, unless expressly stated to the contrary, “or” refers to an inclusive- or and not to an exclusive- or. For example, a condition A or B is satisfied by any one of the following: A is true or present) and B is false (or not present), A is false (or not present) and B is true (or present), and both A and B are true (or present).

Approximating language, as used herein throughout the specification and claims, is applied to modify any quantitative representation that could permissibly vary without resulting in a change in the basic function to which it is related. Accordingly, a value modified by a term or terms, such as “about,” “approximately,” and “substantially,” are not to be limited to the precise value specified. In at least some instances, the approximating language may correspond to the precision of an instrument for measuring the value, or the precision of the methods or machines for constructing or manufacturing the components and/or systems. For example, the approximating language may refer to being within a 10 percent margin.

Here and throughout the specification and claims, range limitations are combined and interchanged, such ranges are identified and include all the sub-ranges contained therein unless context or language indicates otherwise. For example, all ranges disclosed herein are inclusive of the endpoints, and the endpoints are independently combinable with each other.

Benefits, other advantages, and solutions to problems are described below with regard to specific embodiments. However, the benefits, advantages, solutions to problems, and any feature(s) that may cause any benefit, advantage, or solution to occur or become more pronounced are not to be construed as a critical, required, or essential feature of any or all the claims.

In general, a laser calibration device in accordance with one or more embodiments described herein can be configured to be used during calibration of an energy beam used in additive manufacturing processes. During calibration, the laser calibration device can be disposed at, or adjacent to, the build plate. The laser calibration device can be removably installed in the additive manufacturing process chamber when calibrating the system. In an embodiment, the laser calibration device includes a body defining a plurality of holes, a photodiode, and a reflective element, e.g., a coating disposed on at least a portion of the body, configured to optically couple the photodiode with the energy beam through the plurality of holes. The photodiode may not be in direct optical communication with the laser light source. Instead, emitted light from the laser light source can be redirected, e.g., reflected, to the photodiode by the coating.

During calibration, the energy beam is passed over the plurality of holes in a calibration pattern. The calibration pattern may define a relative path of travel of the energy beam (e.g., a matrix of coordinates to follow), a relative travel velocity, or both. The photodiode can detect when the energy beam passes over each of the plurality of holes. In an embodiment, each hole may be detected by the photodiode as an impulse. Conversely, the photodiode can detect a lack of impulse when the energy beam is not over a hole, i.e., when the energy beam is positioned at a location in between holes where the photodiode is prevented from receiving the energy beam.

With the energy beam moving relative to the laser calibration device, the photodiode can be configured to sense one or more parameters of the received energy beam. By way of example, these one or more parameters can include a sensed duration of time between successive impulses of the energy beam. One or more processors can be in electrical communication with the photodiode. The one or more processors can be configured to compare the sensed parameters to an expected set of parameters and use the difference to generate calibrating instructions. The calibrating instructions may inform adjustment of one or more elements of the laser light source or associated components. In certain instances, the calibrating instructions can be automatically applied to the additive manufacturing system, i.e., the system can automatically adjust in response to the calibrating instructions. In other instances, the calibrating instructions can be input, e.g., by a human operator, into the system to calibrate the system to baseline, or other preset, condition.

Referring to the Figures, FIG. 1 illustrates a schematic view of an additive manufacturing system 100 in accordance with an embodiment. The system 100 generally includes an additive manufacturing process chamber 102 defining a work area. The additive manufacturing process chamber 102 can include a closed chamber, a semi-closed chamber, or an open chamber. Inside the work area is disposed a build plate 104 defining a build surface 106 on which an additively manufactured three-dimensional object can be constructed one layer at a time.

The system 100 can further include a light source, e.g., a laser light source 108, disposed within, or adjacent to the additive manufacturing process chamber 102. The laser light source 108 can be configured to emit an energy beam 110. In the illustrated embodiment, the energy beam 110 is emitted from the laser light source 108 in a direction generally parallel with the build surface 106. The energy beam 110 can be redirected, e.g., angularly reflected, by a beam guiding element 112. The beam guiding element 112 can include, for example, a galvo mirror 114 or another energy beam guiding element that is moveable about an adjustable interface 116 and directs the energy beam 110 to the build surface 106 across its two dimensional surface. The galvo mirror 114 may be moved, for example, by one or more high speed motors configured to redirect the energy beam 110 toward the build surface 106 in a desired direction or pattern. When used for additive manufacturing, the beam guiding element 112 can be configured to redirect the energy beam 110 along a pattern associated with build instructions relating to the three-dimensional object to be built on the build plate 104. For instance, the beam guiding element 112 can move an irradiation point 124 of the energy beam 110 on the build plate 104 in accordance with a specified pattern so as to selectively irradiate the medium on the build plate 104 and form a layer of the three-dimensional object. In certain embodiments, the beam guiding element 112 can include a single reflecting element, e.g., a single mirror 114. In other embodiments, the beam guiding element 112 can include a plurality of reflecting elements, e.g., a plurality of mirrors 114. The plurality of mirrors 114 can act together to redirect the irradiation point 124 of the energy beam 110 relative to the build plate 104. For example, a first beam guiding element may control movement of the energy beam 110 in the X axis while a second beam guiding element may control movement of the energy beam 110 in the Y axis. The beam guiding element 112 can additionally include one or more further mirrors or other guiding elements, filters, lenses, and the like. The irradiation point 124 of the energy beam 110 can generally be moved along the build plate 104 by adjusting the angle of the beam guiding element 112. The energy beam 110 can move in a range 118 of angles, e.g., from a first angle 120 to a second angle 122, by means of the beam guiding element 112.

Before certain additive manufacturing operations, or even at preset intervals, it may be desirable to calibrate the system 100. More specifically, it is possible that over time the actual location of the irradiation point 124 may deviate from an expected location. For instance, slight deviations in angular orientation of the beam guiding element 112 may result in X-, Y-misalignment of the irradiation point 124. These deviations may become more pronounced over long emission distances, e.g., between the beam guiding element 112 and the build plate 104. Calibration may include the sensing of this misalignment and the generation of calibration instructions to correct the misalignment.

In accordance with an embodiment of the present disclosure, a laser calibration device 126 can generally include a device configured to sense misalignment of the energy beam 110. The sensed misalignment can then be analyzed by one or more processors to generate calibration instructions.

The laser calibration device 126 can generally include a body 128. The body 128 can define a cavity 130. A surface of the body 128, e.g., a cover 132, can include a plurality of holes 134. The holes 134 can extend through the cover 132 optically connecting the cavity 130 of the body 128 with the additive manufacturing process chamber 102. During calibration, the energy beam 110 can pass through the holes 134 in the cover 132 and enter the cavity 130. The energy beam 110 can reflect/scatter off a coating 136 disposed within the cavity 130. The resulting reflected energy beam 138 can travel to and be received by a photodiode 140. While the reflected energy beam 138 is depicted in FIG. 1 with the energy beam 110 at the first and second angles 120 and 122, it should be understood that the energy beam 110 can be redirected to the photodiode 140 at any angle where the energy beam 110 passes through at least one of the holes 134 and enters the cavity 130.

In an embodiment, the photodiode 140 can include a photodiode that is sensitive to the energy beam wavelength, such as a Si photodiode that may be used in DMLM lasers. The photodiode 140 can have a fast response time, typically less than 1 μs. The photodiode 140 can have an active sensing area in a range of, e.g., 1 mm to 50 mm.

The coating 136 can generally include a diffuse-reflective coating. The coating 136 can form a surface that reflects incident energy beam 110 in all directions. In an embodiment, the coating 136 can form a rough surface. By way of example, the coating 136 can be a polymeric powder slurry that is applied, e.g., sprayed, onto the surface of the cavity 130. In other exemplary embodiments, the coating 136 can include a polytetrafluoroethylene (PTFE) material, e.g., a sheet that is bonded (e.g., glued) to the surface of the cavity 130. The coating 136 can also be formed through sand-blasting, surface etching, or the like so as to enable desirable diffuse reflection. The coating 136 can be selected to interact with the wavelength of the energy beam 110. In certain instances, the coating 136 can have low energy absorption properties and high thermal resistance (e.g., resistance to temperatures of at least 400° F., such as at least 450° F., such as at least 500° F.). However, it should be understood that the material(s), application process(es), physical and optical property(ies) or other attribute(s) of the coating 136 is/are not intended to be limited by the above exemplary description.

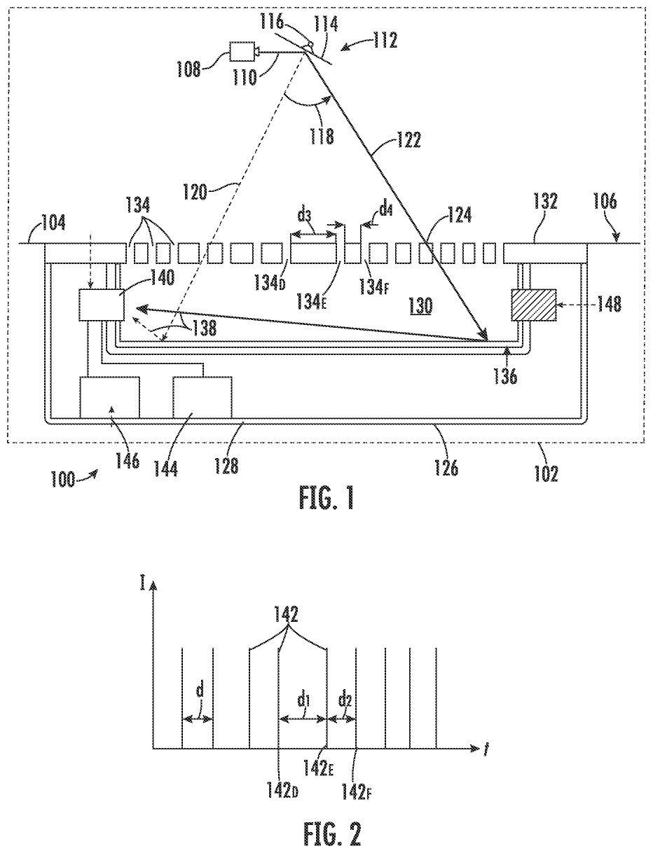

FIG. 2 illustrates a plot of an exemplary signal from the photodiode 140 with the X-axis representing time t and the Y-axis representing sensed input of the energy beam 110, and more particularly, of the reflected/scattered energy beam 138. In a particular embodiment, time t can be measured in milliseconds (ms).

The plot in FIG. 2 illustrates nine sensed energy inputs/pulses 142 at the photodiode 140, each spaced apart by from one another by a distance d. The nine sensed energy inputs 142 correspond with the nine holes 134 depicted between and including the first and second angles 120 and 122 in FIG. 1. That is, each of the sensed energy inputs 142 in the plot of FIG. 2 can correspond with a time at which the energy beam 110 passes through one of the respective holes 134 in the laser calibration device 126 and is redirected to the photodiode 140 by the coating 136. As such, the distances d between adjacent energy inputs 142 can correspond with times when the energy beam 110 is blocked by the laser calibration device 126, i.e., the energy beam 110 is not actively passing through any of the holes 134.

In the illustrated embodiment, a fourth sensed energy input 142_{D} is spaced apart from a fifth sensed energy input 142_{E} by a first distance d₁ that is greater than a second distance d₂ between the fifth sensed energy input 142_{E} and a sixth sensed energy input 142F. The relative distances d₁ and d₂ can correspond to the relative distances between the holes 134 through which the energy beam 110 successively passes. For example, referring again to FIG. 1, a fourth hole 134_{D} can be spaced apart from a fifth hole 134_{E} by a distance, d₃, correspondingly greater than a distance, d₄, between the fifth hole 134_{E} and a sixth hole 134_{F}. The difference between d₃ and d₄ can be directly related to the resulting distances d₁ and d₂ detected by the photodiode 140. As a result, as the distance d₃ increases, the distance d₁ can increase by a same, or scaled, amount.

The photodiode 140 can be in communication with a power source 144 and one or more processors 146. In an embodiment, the processor(s) 146 can be disposed locally, e.g., within the system 100. For instance, the processor(s) 146 can be integrated into the system 100 or coupled therewith through a hardwire or wireless interface. In another embodiment, the processor(s) 146 can be remote, e.g., in the cloud. In an exemplary process, the processor(s) 146 can be configured to receive the signal from the photodiode 140 and determine system error. As previously described, in an embodiment this error may be caused by the beam guiding element 112. The processor(s) 146 may further determine and generate calibrating instructions for removing the error from the system 100. These calibrating instructions may include, for example, motor commands which recalibrate the beam guiding element 112 e.g., to a default or modified ideal position, one or more adjustment factors which adjust inputs associated with the additive manufacturing process to overcome misalignment, or the like. By way of example, adjustment factors may consider system error and automatically adjust printing instructions to account for this system error.

In an embodiment, the system 100 can be used to calibrate laser scanning speed which may be a factor in affecting build quality. Scanning speeds that are off from a prescribed speed can result in generation of lower than expected thermal input, and thus a lack of fusion or porosity in the part being additively manufactured, or higher than expected scanning speeds, and thus occurrence of pin-holes or recoating failure.

In an embodiment, the system 100 can further include an energy absorption element 148, e.g., a coating. The energy absorption element 148 depicted in FIG. 1 can be configured to absorb at least a portion of the energy beam 110 to prevent the photodiode 140 from receiving erroneously reflected energy or direct energy from the energy beam 110. The energy absorption element 148 can be disposed within or adjacent to the cavity 130.

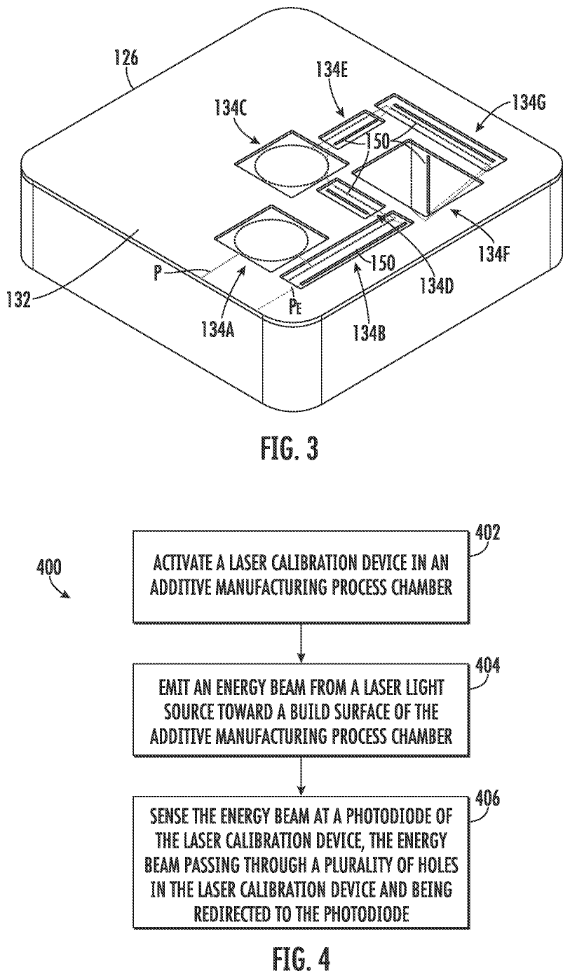

FIG. 3 illustrates a perspective view of the laser calibration device 126 in accordance with an exemplary embodiment of the present disclosure. The laser calibration device 126 can be removable from the system 100. For example, the body 128 of the laser calibration device 126 can be removable from the build plate 104 (FIG. 1). In this regard, the build plate 104 can be utilized in additive manufacturing processes after the laser calibration device 126 is removed from the build plate 104, or even the additive manufacturing process chamber 102, and the laser calibration device 126 is made ready to use, e.g., a void where the laser calibration device 126 was previously located is covered. The laser calibration device 126 can be stored for repeat use in future calibration operations.

The cover 132 of the laser calibration device 126 is shown with a plurality of holes 134. The plurality of holes 134 are divided into a plurality of sets of holes, including, e.g., a first set of holes 134A, a second set of holes 134B, a third set of holes 134C, a fourth set of holes 135D, a fifth set of holes 135E, a sixth set of holes 135F, or a seventh set of holes 135G. Each set of holes 134A, 134B, 134C, 134D, 134E, 134F and 134G can include a plurality of discrete holes. Each discrete hole may be similar or dissimilar to one or more of the other discrete holes. Each set of holes 134A, 134B, 134C, 134D, 134E, 134F and 134G can define a shape as seen from a top view. The shape can be formed by the plurality of discrete holes. For instance, the first and third set of holes 134A and 134C depicted in FIG. 3 define curved paths whereas the second, fourth, fifth, sixth and seventh set of holes 134B, 134D, 134E, 134F and 134G define straight paths oriented at different relative angles. In an embodiment, at least two of the straight paths can lie along parallel lines. In another embodiment, at least two of the straight paths can lie along angularly offset lines. For instance, the straight lines can be angularly offset by at least 1°, such as by at least 5°, such as by at least 25°, such as by at least 45°, such as by at least 80°.

As previously described, the beam guiding element 112 may be subject to misalignment and system error, e.g., as a result of use. This error can manifest in the irradiation point 124 of the energy beam 110 (FIG. 1) being moved from its intended location at any given point during the manufacturing process. Using the laser calibration device 126, the system 100 can be calibrated by initially moving the energy beam 110 in a calibration pattern P along the cover 132. The calibration pattern P generally causes the energy beam 110 to follow a path over each of the discrete holes 134. In an exemplary embodiment, the path over each set of holes can be formed by a shortest line between each of the discrete holes, a centerline of the discrete holes, along only the X- and Y-axis, or another suitable path design. In an embodiment, the energy beam 110 can be moved between each set of holes 134A, 134B, 134C, 134D, 134E, 134F and 134G. In another embodiment, the energy beam 110 can be moved between less than all sets of holes 134A, 134B, 134C, 134D, 134E, 134F and 134G.

In certain instances, at least one set of holes 134A, 134B, 134C, 134D, 134E, 134F and 134G can include different types of discrete holes. For example, in the illustrated embodiment, the second, fourth, fifth, sixth, and seventh sets of holes 134B, 134D, 134E, 134F and 134G each further include an elongated hole 150. The elongated holes 150 are shown adjacent to the holes 134 discussed with respect to FIG. 1. The energy beam 110 can be moved over the elongated holes 150, e.g., in a pattern P_{E} over the elongated holes 150. The patterns P and P_{E} depicted in FIG. 3 are merely exemplary. In other embodiments, the pattern may follow a different order through the sets of holes or even over each discrete hole. For instance, the pattern may alternate the energy beam 110 between the holes 134 shown and described in FIG. 1, and the elongated holes 150. In an embodiment, the elongated holes 150 can be used by the laser calibration device 126 for sensing average speed of the energy beam 110. In another embodiment, the holes 134 can be used to sense instant speed of the energy beam 110.

The photodiode 140 can receive the redirected energy beam 138 as the irradiation point 124 moves across the build surface 106. In an embodiment, the photodiode 140 can communicate with the processor(s) 146 to form calibrating instructions in view of misalignments between expected receipt time of the energy beam 110 based on the known pattern of movement and the actual receipt of the energy beam 110.

FIG. 4 illustrates a method 400 of calibrating a laser light sourced used in additive manufacturing processes. The method 400 includes a step 402 of activating a laser calibration device in an additive manufacturing process chamber. The step 402 can further include installing, e.g., positioning, hardwiring, etc., the laser calibration device in the additive manufacturing process chamber. Positioning the laser calibration device can be performed such that an effective surface of the laser calibration device, i.e., the surface receiving the energy beam, is generally coplanar with the build surface. As noted above, use of the term process chamber is not limited to closed processing chambers. In certain instances, semi-open or even open process chambers may be utilized.

The method 400 further includes a step 404 of emitting an energy beam from a laser light source toward a build surface of the additive manufacturing process chamber. In certain instances, the energy beam can contact the build surface, or a surface of the laser calibration device, at or near an irradiation point thereof. The method 400 further includes a step 406 of sensing the energy beam at a photodiode of the laser calibration device. The energy beam passes through a plurality of holes in the laser calibration device and is redirected to the photodiode. In an embodiment, the step 406 of sensing the energy beam at the photodiode can be performed while moving the laser calibration device and the emitted energy beam relative to one another. That is, the irradiation point of the energy beam can be moved around the laser calibration device. The irradiation point may follow a calibration pattern. The calibration pattern can be preset based at least in part on a geometric pattern of the plurality of holes in the laser calibration device. The calibration pattern can include, e.g., patterns P or P_{E} or P+P_{E} as depicted in FIG. 3.

In an embodiment, the step 406 of sensing the energy beam can include sensing impulses of the energy beam, each impulse corresponding to the energy beam passing through a different hole of the plurality of holes. The step 406 can further include determining a characteristic of the sensed impulses and generating calibrating instructions in response thereto. In an embodiment, the calibrating instructions can be generated at least in part by comparing the determined characteristic to an expected characteristic. By way of example, the characteristic of the sensed impulse may relate to the duration of time between successive impulses. The determined time can be compared against an expected time for a calibrated system. The resulting difference can be utilized to generate calibrating instructions.

Use of hole sets arranged in non-linear shapes, as viewed from a top view, (e.g., the first and third sets of holes 134A and 134C in FIG. 3) may permit a more detailed or faster calibration process. For instance, many beam guiding elements 112 utilize a plurality of reflective elements for traversing an X-Y-build plate. A first reflective element may control the X-axis of the energy beam 110 while a second reflective element controls the Y-axis of the energy beam 110. Moving the energy beam 110 in a complex shape, e.g., a circle, a polygon, a zig-zag, or the like, may permit quicker analysis of both the first and second reflective elements, e.g., through simultaneous sensing of movement along both axis. Additionally, other errors may appear as a result of a selected point-by-point advancement protocols and the like. Diagonally offset hole sets, as viewed from a top view, (e.g., the sixth set of holes 134F) may also permit quicker analysis of both the first and second reflective elements. The two reflective elements can alternatively be calibrated individually, for example, using a first set of holes (e.g., the second set of holes 134B) and a second set of holes (e.g., the fourth set of holes 134D) that are angularly offset, e.g. lie along perpendicular lines.

Some additive manufacturing machines have multiple optical channels. Laser calibration devices in accordance with embodiments described herein can be used for calibration of each optical channel. Moreover, misalignment among the optical channels may be determined, e.g., inferred, in view of sensor data analysis. For example, a command of a scan pattern can be provided to a first optical system which can cause receipt of the scan signal from the photodiode sensor. The same scan pattern can be provided to a second optical system which can cause receipt of a second scan signal from the photodiode sensor. The sensor signals from the first and second optical signals can be analyzed to identify misalignment between the two systems.

Further aspects of the invention are provided by the subject matter of the following clauses:

Embodiment 1. A laser calibration device for calibrating an energy beam used in additive manufacturing, the laser calibration device comprising: a body configured to be disposed in an additive manufacturing process chamber; a cover for the body, the cover comprising a plurality of holes; a photodiode; and a coating disposed on the body and configured to optically couple the photodiode with the plurality of holes, wherein the photodiode is configured to sense one or more parameters of the energy beam for determining calibrating instructions for the energy beam.

Embodiment 2. The laser calibration device of any one or more of the embodiments, wherein the plurality of holes comprises at least two sets of holes, each set of holes defining a geometric shape in the cover as seen from a top view.

Embodiment 3. The laser calibration device of any one or more of the embodiments, wherein at least one of the sets of holes defines a straight path, and wherein at least one of the sets of holes defines a curved path.

Embodiment 4. The laser calibration device of any one or more of the embodiments, wherein a first set of holes defines a straight path forming a first straight line, wherein a second set of holes defines a straight path forming a second straight line, and wherein the first and second straight lines are angularly offset from one another by at least 1°.

Embodiment 5. The laser calibration device of any one or more of the embodiments, wherein the cover further comprises one or more elongated holes disposed adjacent to at least one of the sets of holes.

Embodiment 6. The laser calibration device of any one or more of the embodiments, wherein the photodiode is configured to sense average speed of the energy beam using the elongated holes, and wherein the photodiode is configured to sense instant speed of the energy beam using the at least one set of holes.

Embodiment 7. The laser calibration device of any one or more of the embodiments, wherein the photodiode comprises a single photodiode.

Embodiment 8. The laser calibration device of any one or more of the embodiments, wherein the laser calibration device is configured to identify misalignment between a plurality of optical channels of an additive manufacturing system.

Embodiment 9. The laser calibration device of any one or more of the embodiments, wherein the cover is configured to be disposed at a vertical height corresponding with a build surface of a build plate in the additive manufacturing process chamber.

Embodiment 10. The laser calibration device of any one or more of the embodiments, wherein the coating is disposed along an internal cavity of the body, and wherein the internal cavity further comprises at least one surface having an energy absorbing coating configured to absorb a portion of the energy beam.

Embodiment 11. The laser calibration device of any one or more of the embodiments, wherein the photodiode is in communication with one or more processors configured to determine the calibrating instructions from the one or more sensed parameters sensed by the photodiode, and wherein the calibrating instructions include information to adjust a parameter of the energy beam.

Embodiment 12. An additive manufacturing system comprising: an additive manufacturing process chamber having a build plate defining a build surface; a laser light source configured to emit an energy beam toward the build surface; and a laser calibration device disposed along the build surface, the laser calibration device comprising: a body configured; a cover for the body, the cover comprising a plurality of holes; a photodiode; and a coating disposed on the body and configured to optically couple the photodiode with the plurality of holes, wherein the photodiode is configured to sense one or more parameters of the energy beam for determining calibrating instructions for the energy beam.

Embodiment 13. The additive manufacturing system of any one or more of the embodiments, wherein the laser calibration device is removable from the additive manufacturing process chamber.

Embodiment 14. The additive manufacturing system of any one or more of the embodiments, wherein the plurality of holes comprises at least two sets of holes, each set of holes defining a geometric shape in the cover as seen from a top view, wherein at least one of the sets of holes defines a straight path and at least one of the sets of holes defines a curved path, and wherein the cover further comprises one or more elongated holes disposed adjacent to at least one of the sets of holes.

Embodiment 15. The additive manufacturing system of any one or more of the embodiments, wherein the photodiode comprises a single photodiode, and wherein an optical input of the photodiode is oriented generally parallel with the build surface.

Embodiment 16. A method of calibrating a laser light source used in additive manufacturing, the method comprising: activating a laser calibration device in an additive manufacturing process chamber; emitting an energy beam from the laser light source toward a build surface of the additive manufacturing process chamber; sensing the energy beam at a photodiode of the laser calibration device, the energy beam passing through a plurality of holes in the laser calibration device and being redirected to the photodiode.

Embodiment 17. The method of any one or more of the embodiments, further comprising moving the laser calibration device and emitted energy beam relative to one another while sensing the energy beam at the photodiode.

Embodiment 18. The method of any one or more of the embodiments, wherein sensing the energy beam comprises sensing impulses of the energy beam, each impulse corresponding to the energy beam passing through a different hole of the plurality of holes; and determining a characteristic of the sensed impulses; and generating calibrating instructions in response to the determined characteristic of the sensed impulses.

Embodiment 19. The method of any one or more of the embodiments, wherein generating calibration instructions comprises comparing the determined characteristic to an expected characteristic.

Embodiment 20. The method of any one or more of the embodiments, wherein emitting the energy beam from the laser light source is performed by moving the energy beam along the build surface in a calibration pattern, and wherein the calibration pattern is preset based at least in part on a geometric pattern of the plurality of holes.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal language of the claims.

What is claimed is:

1. A laser calibration device for calibrating an energy beam used in additive manufacturing, the laser calibration device comprising:
a body configured to be disposed in an additive manufacturing process chamber;
a cover for the body, the cover comprising a plurality of holes;
a photodiode; and
a coating disposed on the body and configured to optically couple the photodiode with the plurality of holes, wherein the photodiode is configured to sense one or more parameters of the energy beam for determining calibrating instructions for the energy beam.

2. The laser calibration device of claim 1, wherein the plurality of holes comprises at least two sets of holes, each set of holes defining a geometric shape in the cover as seen from a top view.

3. The laser calibration device of claim 2, wherein at least one of the sets of holes defines a straight path, and wherein at least one of the sets of holes defines a curved path.

4. The laser calibration device of claim 2, wherein a first set of holes defines a straight path forming a first straight line, wherein a second set of holes defines a straight path forming a second straight line, and wherein the first and second straight lines are angularly offset from one another by at least 1°.

5. The laser calibration device of claim 2, wherein the cover further comprises one or more elongated holes disposed adjacent to at least one of the sets of holes.

6. The laser calibration device of claim 5, wherein the photodiode is configured to sense average speed of the energy beam using the elongated holes, and wherein the photodiode is configured to sense instant speed of the energy beam using the at least one set of holes.

7. The laser calibration device of claim 1, wherein the photodiode comprises a single photodiode.

8. The laser calibration device of claim 1, wherein the laser calibration device is configured to identify misalignment between a plurality of optical channels of an additive manufacturing system.

9. The laser calibration device of claim 1, wherein the cover is configured to be disposed at a vertical height corresponding with a build surface of a build plate in the additive manufacturing process chamber.

10. The laser calibration device of claim 1, wherein the coating is disposed along an internal cavity of the body, and wherein the internal cavity further comprises at least one surface having an energy absorbing coating configured to absorb a portion of the energy beam.

11. The laser calibration device of claim 1, wherein the photodiode is in communication with one or more processors configured to determine the calibrating instructions from the one or more sensed parameters sensed by the photodiode, and wherein the calibrating instructions include information to adjust a parameter of the energy beam.

12. An additive manufacturing system comprising:
an additive manufacturing process chamber having a build plate defining a build surface;
a laser light source configured to emit an energy beam toward the build surface; and
a laser calibration device disposed along the build surface, the laser calibration device comprising:
a body configured;
a cover for the body, the cover comprising a plurality of holes;
a photodiode; and
a coating disposed on the body and configured to optically couple the photodiode with the plurality of holes, wherein the photodiode is configured to sense one or more parameters of the energy beam for determining calibrating instructions for the energy beam.

13. The additive manufacturing system of claim 12, wherein the laser calibration device is removable from the additive manufacturing process chamber.

14. The additive manufacturing system of claim 12, wherein the plurality of holes comprises at least two sets of holes, each set of holes defining a geometric shape in the cover as seen from a top view, wherein at least one of the sets of holes defines a straight path and at least one of the sets of holes defines a curved path, and wherein the cover further comprises one or more elongated holes disposed adjacent to at least one of the sets of holes.

15. The additive manufacturing system of claim 12, wherein the photodiode comprises a single photodiode, and wherein an optical input of the photodiode is oriented generally parallel with the build surface.

16. A method of calibrating a laser light source used in additive manufacturing, the method comprising:
activating a laser calibration device in an additive manufacturing process chamber;
emitting an energy beam from the laser light source toward a build surface of the additive manufacturing process chamber;
sensing the energy beam at a photodiode of the laser calibration device, the energy beam passing through a plurality of holes in the laser calibration device and being redirected to the photodiode.

17. The method of claim 16, further comprising moving the laser calibration device and emitted energy beam relative to one another while sensing the energy beam at the photodiode.

18. The method of claim 16, wherein sensing the energy beam comprises
sensing impulses of the energy beam, each impulse corresponding to the energy beam passing through a different hole of the plurality of holes; and
determining a characteristic of the sensed impulses; and
generating calibrating instructions in response to the determined characteristic of the sensed impulses.

19. The method of claim 18, wherein generating calibration instructions comprises comparing the determined characteristic to an expected characteristic.

20. The method of claim 16, wherein emitting the energy beam from the laser light source is performed by moving the energy beam along the build surface in a calibration pattern, and wherein the calibration pattern is preset based at least in part on a geometric pattern of the plurality of holes.
